(19) United States
(12) Patent Application Publication
(10) Pub. No.: US 2016/0132435 A1
(43) Pub. Date: May 12, 2016

(54) SPINLOCK RESOURCES PROCESSING

(71) Applicant: HANGZHOU H3C TECHNOLOGIES CO., LTD., Hangzhou City (CN)

(72) Inventor: Yibin GONG, Beijing (CN)

(73) Assignee: Hangzhou H3C Technologies Co., Ltd., Hangzhou City (CN)

(21) Appl. No.: 14/891,839

(22) PCT Filed: Apr. 3, 2014
(86) PCT No.: PCT/CN2014/074695

§ 371 Date: Nov. 17, 2015

(30) Foreign Application Priority Data
May 17, 2013 (CN) 201310189093.2

(51) Int. Cl. G06F 12/08; G06F 9/50

(52) U.S. Cl. CPC G06F 12/0897; G06F 9/5016; G06F 12/0842; G06F 2212/62; G06F 2212/283

(57) ABSTRACT

According to an example, in a spinlock processing method, a value of a spinlock cache variable may be read from a cache and the value of the spinlock cache variable may be written into a register. A determination may be made as to whether the value of the spinlock cache variable is an initial value. If yes, the value of the spinlock cache variable in the register may be updated. A determination may also be made as to whether the spinlock cache variable is accessed by a core after the value of the spinlock cache variable is written into the register. If yes, a value of a spinlock cache variable may be obtained from the cache. If no, the updated value of the spinlock cache variable may be written into the cache. Moreover, an access speed of the cache may be larger than an access speed of an L2 cache.

### BACKGROUND

With the enhancement of processing performance requirements of network devices, multi-core processors have been widely used. Generally, critical resources may be set in a processing system, in which the critical resources are resources that allow only one process to be accessed at a time, i.e., the resources are exclusively accessed by multiple cores. A spinlock may be set when software is designed to prevent the multiple cores from accessing the same critical resource simultaneously.

### BRIEF DESCRIPTION OF THE DRAWINGS

FIG. 1 is a schematic diagram illustrating the hardware architecture of a spinlock in accordance with an example of the present disclosure;

FIG. 2 is a schematic diagram illustrating the structure of a spinlock processing device in accordance with an example of the present disclosure;

FIG. 3 is a flow chart illustrating a spinlock processing method in accordance with an example of the present disclosure; and

FIG. 4 is a schematic diagram illustrating the structure of another spinlock processing device in accordance with an example of the present disclosure.

### DETAILED DESCRIPTION

For simplicity and illustrative purposes, the present disclosure is described by referring mainly to example(s) thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

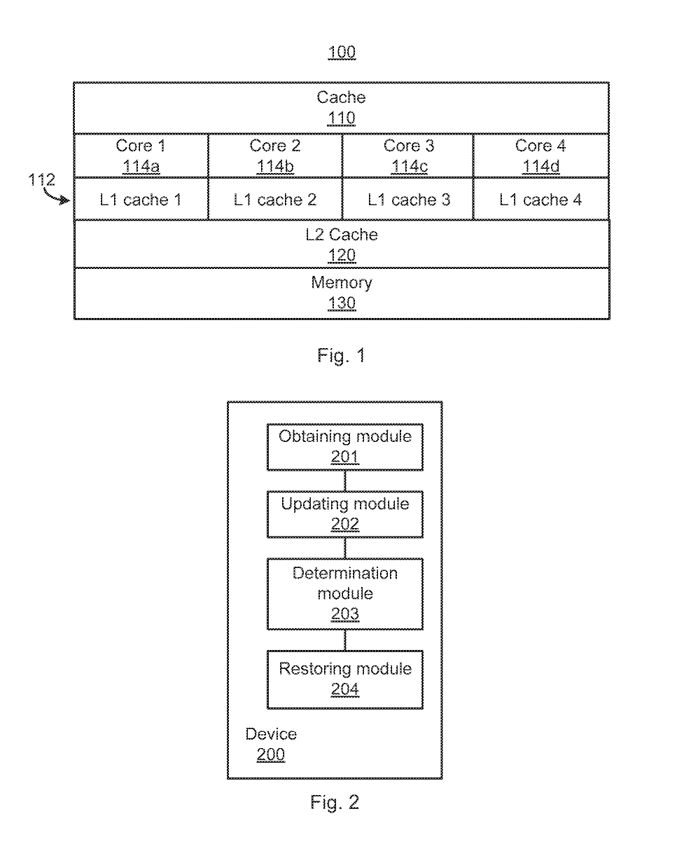

Referring first to FIG. 1, there is shown a schematic diagram illustrating the hardware architecture 100 of a spinlock in accordance with an example of the present disclosure. According to an example, an independent high-speed cache area may be specially designed for the spinlock. For instance, when the CPU is designed, an independent physical cache area may be reserved for the CPU. The physical cache area may be independently accessed and may be shared by all of a plurality of cores 114a-114d.

As shown in FIG. 1, according to an example of the present disclosure, the cache 110 may be a high-speed cache. The access speed of the cache 100 and the access speed of the L1 cache 112 may belong to a same order of magnitude and may be about three to four clock cycles. According to an example of the present disclosure, all of the cores 114a-114d may obtain the spinlock resource via the cache 110. The speed at which the spinlock resource may be accessed may be about three to four cock cycles. The hardware architecture 100 is also depicted as including a L2 cache 120 and a memory 130.

In contrast, in a conventional spinlock architecture, an independent first-level (L1) cache is set on each core of a multi-core processor and all of the cores share a second-level (L2) cache and a memory. In this conventional spinlock architecture, images of globally-shared memory variables are stored in the memory, the L2 cache, and each L1 cache. In addition, when a core operates the spinlock, the memory variables in the L1 cache may be updated, resulting in the memory variables stored in the L1 caches of other cores to become invalid. If the other cores operate the spinlock, the other cores read the memory variables from the L2 cache or the memory. If the memory variables in the L1 cache are invalid, the access speed for obtaining the spinlock by accessing the memory and the L2 cache may be about fifty dock cycles to about one hundred and fifty dock cycles.

Referring now to FIG. 2, there is shown a schematic diagram illustrating the structure of a spinlock processing device 200 in accordance with an example of the present disclosure. According to an example of the present disclosure, the spinlock processing device 200 may include an obtaining module 201, an updating module 202, and a determination module 203. It should, however, be understood that the spinlock processing device 200 may include additional modules without departing from a scope of the spinlock processing device 200 disclosed herein.

The obtaining module 201 may read a value of a spinlock cache variable from a cache 110, write the value of the spinlock cache variable into a register, and determine whether the value of the spinlock cache variable is an initial value.

The updating module 202 may update the value of the spinlock memory variable in the register if the value of the spinlock cache variable is the initial value.

The determination module 203 may determine whether the spinlock cache variable is accessed by a core after the value of the spinlock cache variable is written into the register, inform the obtaining module 201 to read the value of the spinlock cache variable from the cache 110, and write the value of the spinlock cache variable into the register if the spinlock cache variable is accessed by a core 114a and write the value of the spinlock cache variable updated by the updating module 202 into the cache if the spinlock cache variable is not accessed by a core 114a.

According to an example of the present disclosure, an access speed of the cache 110 may be larger than that of the L2 cache 120.

According to an example of the present disclosure, the cache 110 may be shared by multiple cores 114a-114d.

According to an example of the present disclosure, if the value of the spinlock cache variable is not the initial value, the obtaining module 201 may further read the value of the spinlock cache variable from the cache 110, write the value of the spinlock cache variable into the register, and determine whether the newly-read value of the spinlock cache variable is the initial value.

According to an example of the present disclosure, the access speed of the cache 110 may be larger than or equal to that of the Li cache 112.

According to an example of the present disclosure, the device 200 may further include a restoring module 204 to set the value of the spinlock cache variable in the register as the initial value after critical resources are accessed and write the initial value into the cache 110.

According to an example, the modules 201-204 may be software modules, e.g., sets of machine readable instructions, stored in a hardware memory device. In another example, the modules 201-204 may be hardware modules on a hardware device. In a further example, the modules 201-204 may include a combination of software and hardware modules.

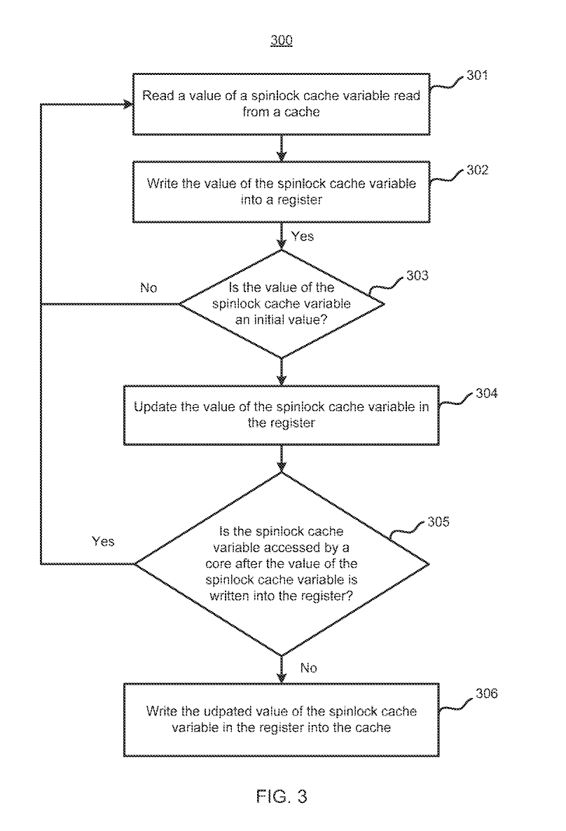

Referring to FIG. 3, there is shown a flow chart illustrating a spinlock processing method 300 in accordance with an example of the present disclosure. FIG. 3 is described with respect to the hardware architecture 100, but may be implemented in hardware having other architectures without departing from a scope of the method 300. In addition, FIG. 3 may include following blocks.

In block 301, a value of a spinlock cache variable may be read from a cache 110. In block 302, the value of the spinlock cache variable may be written into a register. In block 303, a determination may be made as to whether the value of the spinlock cache variable is an initial value. If the value of the spinlock cache variable is the initial value, block 304 may be performed. If the value of the spinlock cache variable is not the initial value, the value of the spinlock cache variable may be read from the cache 110 again and the newly-read value of the spinlock cache variable may be written into the register, as indicated in blocks 301 and 302.

According to an example, the value of the spinlock cache variable may also be called the value of a key of the spinlock in the cache 110.

In a multi-core processing system, the critical resources may be protected by the spinlock. If a core intends to access the critical resources, a spinlock resource may be obtained first. Whether the core has obtained the spinlock resource may be determined according to the value of the spinlock cache variable. Each time an operation is performed on the spinlock, the value of the spinlock cache value may be updated. Initially, the initial value may be set for the value of the spinlock cache variable. For instance, the initial value of the spinlock cache variable may be set as zero, which denotes that the spinlock resource may not be occupied. If the spinlock resource is occupied, the value of the spinlock cache variable may be updated as one.

According to an example, referring to FIG. 1, the method 300 in this example of the present disclosure may be described in detail with respect to the hardware architecture 100 of the spinlock. The cache 110 may be an independent cache area specially designed for the spinlock. When the CPU is designed, an independent physical area may be reserved for the cache 110. The area may be independently accessed and may be shared by all of the cores 114a-114d. According to an example of the present disclosure, the cache 110 may be a high-speed cache. The access speed of the cache 110 and the access speed of the Li cache 112 may belong to a same order of magnitude and may be around three to four dock cycles. According to an example of the present disclosure, all of the cores 114a-114d may obtain the spinlock resource via the cache 110. The speed at which the spinlock resource may be obtained may be around three to four dock cycles. According to an example, if memory variables in the L1 cache 112 are invalid, the L2 cache 120 or the memory 130 may be accessed to obtain the spinlock. The access speed of the L2 cache 120 may be around fifty clock cycles. The access speed of the memory 130 may be slower and may be around one hundred and fifty clock cycles. According to an example of the present disclosure, the high-speed cache may be independently set to quickly access the spinlock resource.

The obtaining module 201 may execute blocks 301-303. That is, the obtaining module 201 may write the value of the spinlock cache variable into the register and perform the determination at block 303. If the value of the spinlock cache variable is the initial value, the spinlock resource may not be occupied and subsequent blocks may be performed. If the value of the spinlock cache variable is not the initial value, the spinlock resource may be occupied and an operation may be performed after other cores release the spinlock resource. The obtaining module 201 may cyclically read the value of the spinlock cache variable (block 301) and perform the determination (block 303), until the spinlock resource is not occupied.

In block 304, the value of the spinlock cache variable in the register may be updated. For instance, the updating module 202 may perform block 304. The value of the spinlock cache variable in the register may be updated as another value. For instance, the initial value, e.g., zero, of the spinlock cache variable may be updated as one.

In block 305, a determination may be made as to whether the spinlock cache variable is accessed by a core after the value of the spinlock cache variable is written into the register. If the spinlock cache variable is accessed by a core, blocks 301-303 may be performed. If the spinlock cache variable is no accessed by a core, block 306 may be performed.

Block 305 may be performed by the determination module 203. If the value of the spinlock cache variable read in block 301 is the initial value, the spinlock may be obtained and the critical resource may be accessed. If the value of the spinlock cache variable is accessed by another core after the value of the spinlock cache variable is accessed by the core and before the value of the spinlock cache variable is updated, both of the cores may determine that the spinlock resource may have been obtained and the critical resources may be accessed, resulting in access conflict.

According to an example of the present disclosure, a determination may be made as to whether the value of the spinlock cache variable may be accessed by another core after the value of the spinlock cache variable is written into the register before the value of the spinlock cache variable in the cache may be modified. The determination as to whether the value of the spinlock cache variable may be accessed by another core may be obtained from a CPU bus. If the value of the spinlock cache variable is accessed by another core, the operation for obtaining the spinlock resource may have failed and block 301 may be re-performed to obtain the spinlock resource again. If the value of the spinlock cache variable is not accessed by another core, the operation for obtaining the spinlock resource may be considered as being successful. The updated value of the spinlock cache variable in the register may be written into the cache to inform other cores that the spinlock resource may be occupied and that the critical resources may be accessed.

In block 306, the updated value of the spinlock cache variable in the register may be written into the cache.

The method may further include setting of the value of the spinlock cache variable in the cache as the initial value. A restoring module 204 may perform the setting of the value of the spinlock cache variable in the cache as the initial value. After the critical resources are accessed, the spinlock resource may be released so that other cores may access the spinlock resource. After the critical resources are accessed, the value of the spinlock cache variable in the register may be set as the initial value and the initial value may be written into the cache.

According to an example of the present disclosure, the spinlock resource may be obtained via the following operations.

First, initialization

| Spin_Init (lockkey) | |
|---|---|
| lockkey = 0; | /*initialize lockkey as zero, which denotes that |

the spinlock resource is not occupied */

Second, Lock

Spin_Lock(lockkey)
1:
ll t0, lockkey /*write the value of lockkey into t0 register*/
bnez t0, 1b /*if the t0 does not equal to zero, the spinlock resource

may be obtained, the value of the lockkey may be reloaded to perform the
determination and subsequent operations may be performed until the value
of the lockkey is zero */

li t0, 1 /*set t0 as one */
sc t0, lockkey /*Whether the lockkey is accessed by another core

after reading the lockkey by executing ll may be determined. If the
lockkey is not accessed, the value in the t0 register may be written into
the lockkey. If the lockkey is accessed by another core, the value in the t0
register may not be written into the lockkey. If zero is written into the t0
register, the writing operation of the lockkey may be failed. */

beqz t0, 1b /* If t0 is zero, the previous writing operation may be

failed, the spinlock resource may not be obtained and the instruction in the
first line may be re-executed to obtain the spinlock */

sync

Third, Unlock

| Spin_Unlock(lockkey) | |
|---|---|
| sync | |
| sw zero, lockkey | /* The lockkey may be set as zero, which |

denotes that the spinlock resource may be in an idle status */

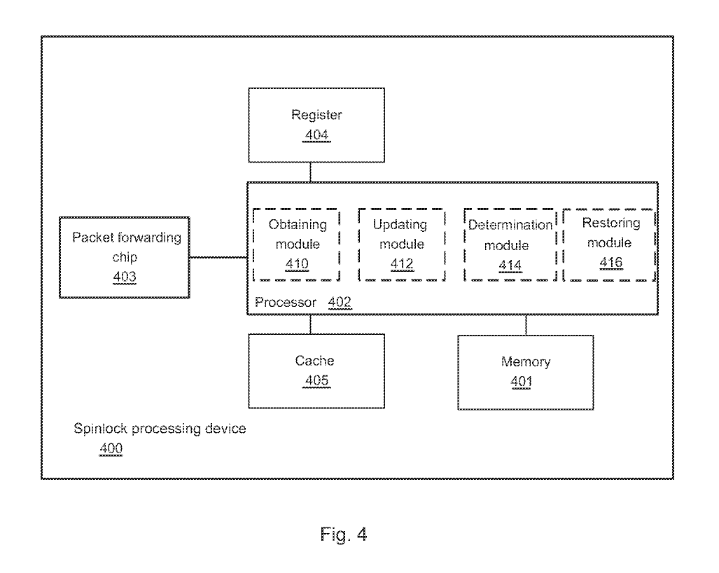

Referring to FIG. 4, there is shown a schematic diagram illustrating the structure of another spinlock processing device 400 in accordance with an example of the present disclosure. The device 400 may include a memory 401, a processor 402, a packet forwarding chip 403, a register 404 and a cache 405. It should, however, be understood that the spinlock processing device 400 may include additional components without departing from a scope of the spinlock processing device 400 disclosed herein.

The processor 402 may include an obtaining module 410, configured to obtain a value of a spinlock cache variable from the cache 405 via the packet forwarding chip 403, write the value of the spinlock cache variable into the register 404 via the packet forwarding chip 403, and determine whether the value of spinlock cache variable is an initial value. The processor 402 may further include an updating module 412, configured to update the value of the spinlock cache variable in the register 404 if the value of the spinlock cache variable is the initial value. The processor 402 may further store a determination module 414, configured to determine whether the spinlock cache variable is accessed by a core after the value of the spinlock cache variable is written into the register 404. The obtaining module 410 may be further configured to read the value of the spinlock cache variable from the cache 405 and write the value of the spinlock cache variable into the register 404 via the packet forwarding chip 403 if the spinlock cache variable is accessed and write the updated value of the spinlock cache variable into the cache 405 via the packet forwarding chip 403 if the spinlock cache variable is not accessed by a core.

An access speed of the cache 405 may be larger than an access speed of an L2 cache 120.

According to an example, the cache 405 may be shared by multiple cores, such as cores 114a-114d.

According to an example, if the value of the spinlock cache variable is not the initial value, the obtaining module 410 may be further configured to read the value of the spinlock cache variable from the cache 405 via the packet forwarding chip 403 again, write the value of the spinlock cache variable into the register 404 via the packet forwarding chip 403, and determine whether the newly-read value of the spinlock cache variable is the initial value.

According to an example, the access speed of the cache 405 may be larger than or equal to the access speed of an L1 cache 112.

According to an example, the processor 402 may further include a restoring module 416, which also be machine readable instructions. The restoring instruction 416 may be configured to set the value of the spinlock cache variable in the register 404 as the initial value after critical resources are accessed and store the initial value in the cache 405 via the packet forwarding chip 403.

According to an example, the obtaining module 410, updating module 412, determination module 414 and restoring module 416 may be implemented by logic circuits inside the processor 402 as shown for example in FIG. 4. According to another example, the obtaining module 410, updating module 412, determination module 414 and restoring module 416 may be implemented as machine readable instructions stored in the memory 401 executed by the processor 402. In a further example, the obtaining module 410, updating module 412, determination module 414 and restoring module 416 may include a combination of machine readable instructions and logic circuits.

In various examples, a module or unit may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

It can be seen from the above description that according to examples of the present disclosure, the cache for storing the value of the spinlock cache variable may be set. Therefore, each core in the multi-core processor may obtain the spinlock resource of the critical resources. Therefore, the operating efficiency of the spinlock may be enhanced and the processing efficiency of the packet forwarding may also be enhanced. Since the multi-core processor may be used on a device having high processing performance requirements, the access efficiency of the critical resources and performance of the device may be enhanced through implementation of the present disclosure.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A spinlock processing device, comprising:
an obtaining module to obtain a value of a spinlock cache variable from a cache, write the value of the spinlock cache variable into a register, and determine whether the value of spinlock cache variable is an initial value;
an updating module to update the value of the spinlock cache variable in the register in response to the value of the spinlock cache variable being the initial value,
a determination module to determine whether the spinlock cache variable is accessed by a core after the value of the spinlock cache variable is written into the register, inform the obtaining module to read the value of the spinlock cache variable from the cache and write the value of the spinlock cache variable into the register if the spinlock cache variable is accessed by the core, and write the value of the spinlock cache variable updated by the updating module into the cache in response to the spinlock cache variable not being accessed by the core; and
wherein an access speed of the cache is larger than an access speed of a second-level cache.

2. The device according to claim 1, wherein the cache is shared by multiple cores.

3. The device according to claim 1, wherein, in response to the value of spinlock cache variable not being the initial value, the obtaining module is further to obtain the value of the spinlock cache variable from the cache, write the value of the spinlock cache variable obtained by the obtaining module into the register and determine whether the value of the spinlock cache variable obtained by the obtaining module is the initial value.

4. The device according to claim 1, wherein the access speed of the cache is larger than or equal to an access speed of a first-level cache.

5. The device according to claim 1, further comprising:
a restoring module to set the value of the spinlock cache variable as in the register as the initial value after critical resources are accessed and write the initial value into the cache.

6. A spinlock processing method, comprising:
A) obtaining a value of a spinlock cache variable from a cache, writing the value of the spinlock cache variable into a register, and determining whether the value of the spinlock cache variable is an initial value;
B) in response to the value of the spinlock cache variable being the initial value, updating the value of the spinlock cache variable in the register;
C) determining whether the spinlock cache variable is accessed by a core after the value of the spinlock cache variable is written into the register;
performing A) in response to the spinlock cache variable being accessed by the core; and
in response to the spinlock cache variable not being accessed by the core, writing the updated value of the spinlock cache variable into the cache,
wherein an access speed of the cache is larger than an access speed of a second-level cache.

7. The method according to claim 6, wherein the cache is shared by multiple cores.

8. The method according to claim 6, further comprising:
performing A) in response to the value of the spinlock cache variable not being the initial value.

9. The method according to claim 6, wherein the access speed of the cache is larger than an access speed of a first-level cache.

10. The method according to claim 6, further comprising:
setting the value of the spinlock cache variable in the register as the initial value after critical resources are accessed and writing the initial value into the cache.
